(19) United States
(12) Patent Application Publication
(10) Pub. No.: US 2015/0052797 A1
(43) Pub. Date: Feb. 26, 2015

(54) COLLAPSIBLE WATERFOWL FLAG

(71) Applicant: Tim Parsons, Napa, CA (US)

(72) Inventor: Tim Parsons, Napa, CA (US)

(21) Appl. No.: 14/460,900

(22) Filed: Aug. 15, 2014

Related U.S. Application Data
(60) Provisional application No. 61/869,575, filed on Aug. 23, 2013.

(51) Int. Cl. A01M 31/06

(52) U.S. Cl. CPC A01M 31/06
USPC 43/2

(57) ABSTRACT

A collapsible waterfowl flag comprises a framework including a shaft, a runner, a pair of arms pivotally attached to the top end of the shaft, a pair of support bars pivotally attached to and extending between the runner and each of the pair of arms, a flexible panel having a body portion attached to and extending along the shaft and two wing portions attached to the pair of arms and extending from opposite sides of the body portion, the framework movable between collapsed and open configurations by moving the runner relative to the shaft between first and second positions, the framework and panel gathered around the shaft in the collapsed configuration, and the arms and support bars extended perpendicularly from the shaft in the open configuration thereby deploying the panel in a substantially planar disposition resembling a flying waterfowl.

### CROSS-REFERENCE TO RELATED APPLICATIONS

This application claims the benefit of U.S. Provisional Application No. 61/869,575 filed Aug. 23, 2013.

### BACKGROUND

1. Field of the Invention

This invention relates to recreational equipment and particularly to hand-operated flags which resemble waterfowl in flight for use during outdoor recreational activities.

2. Description of the Prior Art

Waterfowlers have developed numerous strategies for concealing themselves in natural environments such as by using camouflaged blinds and other camouflaged field gear. Other techniques have evolved over time to attract waterfowl such a lifelike decoys and mechanisms which imitate the actions of waterfowl. One simple apparatus is a waterfowl flag which when waved imitates the flying motions of waterfowl, especially while landing. Waterfowl flags are sometimes employed by extending them from a camouflaged laydown blind and waving the flag.

One example of a prior art waterfowl flag is the goose flag 100 shown in FIG. 1. As shown the goose flag comprises a shaft 102 and two arms 104 which extend roughly perpendicularly from the top end of the shaft 102. The arms 104 are attached to the shaft 102 by inserting the near end 106 of each arm 104 in holes 108 in a receiving head 110 at the top end of the shaft 102 where they are held in place by a combination of friction and tension across the wing span of the flexible panel material 112 supported by the arms 104. While workable, it can be difficult to insert the arms 104 in the holes while simultaneously stretching the fabric panel into a wing formation, especially in frigid early morning field conditions. In addition, the near ends 106 of the arms 104 can occasionally break where inserted into head 110, making the flag unusable.

A second example of a prior art waterfowl flag is the goose flag 120 shown in FIG. 2. In this device, a pivot base 122 is attached to the top of the shaft 124 and each arm 126 is inserted in a sleeve 128 that is pivotally attached to the pivot base as shown. This arrangement allows the arms to be swiveled from an open position, as shown in FIG. 2, to a collapsed position in which the arms are moved downward into parallel alignment with shaft 124. A detent mechanism 130 may be provided to hold each arm 126 in the open position. While the pivot base beneficially allows the arms 126 to be maneuvered between open and collapsed configurations, doing so is awkward because each arm must be separately manipulated. Moreover, the detent mechanism is of limited effectiveness for holding the arms in the open configuration.

There is therefore a need for a waterfowl flag that can be quickly and easily modified from a collapsed to an open position for improved portability and ease of use in the field.

### BRIEF DESCRIPTION OF THE DRAWINGS

FIG. 1 is an upper perspective view of a prior art goose flag;

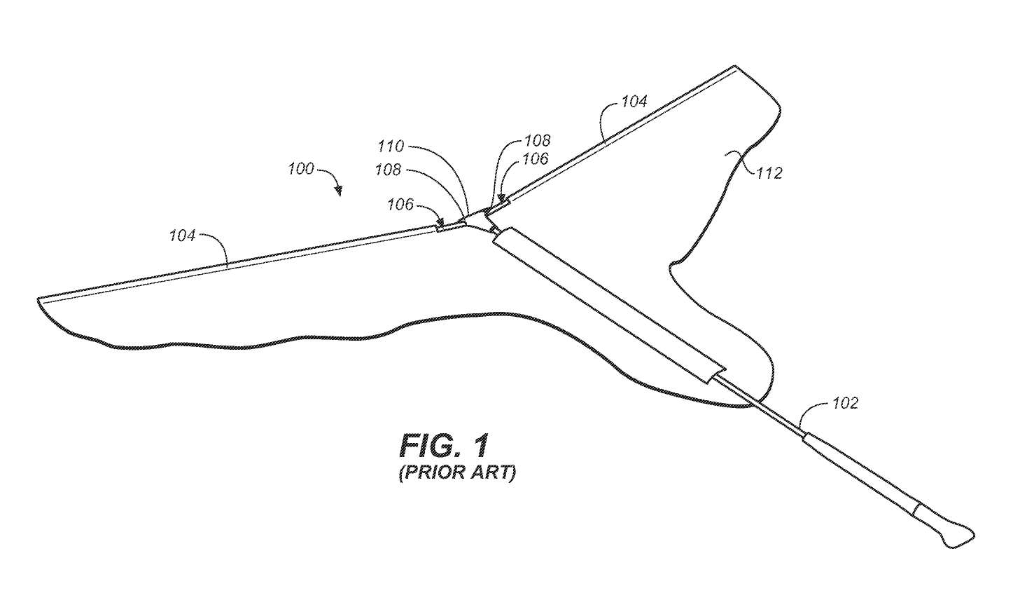

FIG. 2 is an upper perspective view of a second type of prior art goose flag;

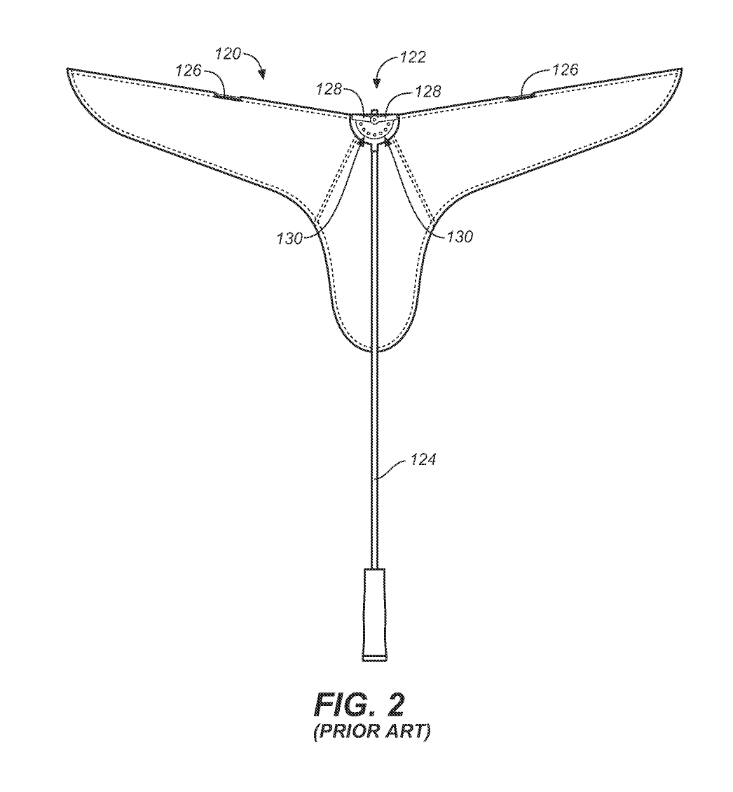

FIG. 3 is an upper perspective view of a collapsible goose flag according to the invention;

FIG. 4A is a plan view of the collapsible goose flag of FIG. 3 shown in a collapsed configuration;

FIG. 4B is a plan view of the collapsible goose flag of FIG. 3 shown in a configuration midway between collapsed and open configurations;

FIG. 4C is a plan view of the collapsible goose flag of FIG. 3 shown in an open configuration;

FIG. 5 is a close up plan view of a portion of the collapsible goose flag of FIG. 4A showing the shaft, runner, support arms and panel collapsed around the shaft;

FIG. 6 is a dose up plan view of a portion of the collapsible goose flag of FIG. 4C showing the top end of the shaft, arms, support bars, and panel in the open configuration;

FIG. 7 is an upper perspective view of a collapsible goose flag being waved up and down while extended from a generic laydown hunting blind.

### DETAILED DESCRIPTION OF THE ILLUSTRATED EMBODIMENT

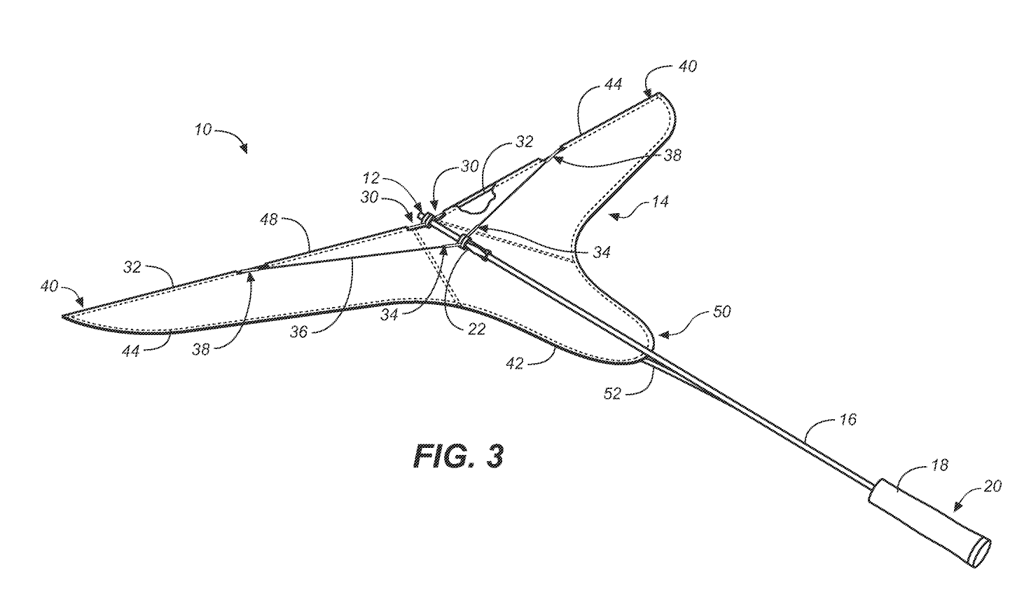

The invention is now described in detail with respect to the accompanying drawing figures. A collapsible goose flag is referred to generally at numeral 10 in FIG. 3. The illustrated embodiment shows a waterfowl flag that is intended to imitate a flying goose, and the invention will hereafter be referred to as a goose flag. The invention, however, is not limited to goose flags and is intended to embrace flags that imitate other types of waterfowl.

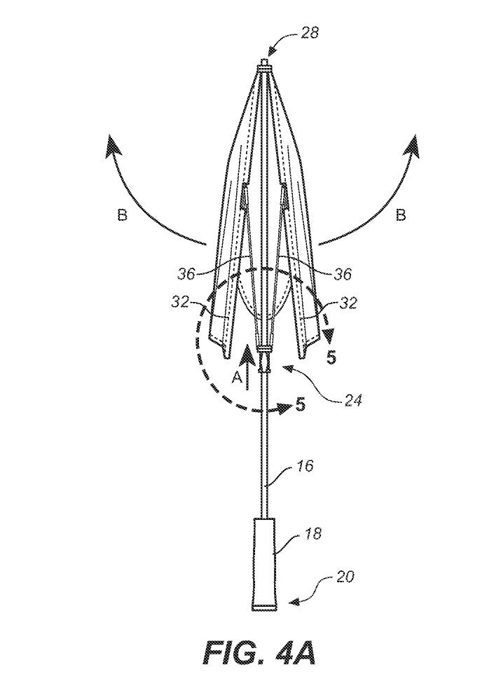

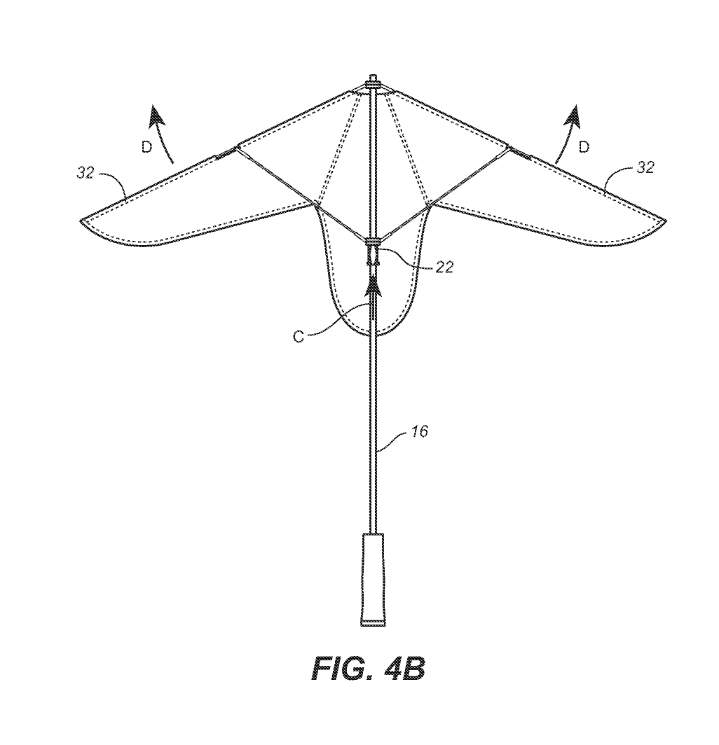

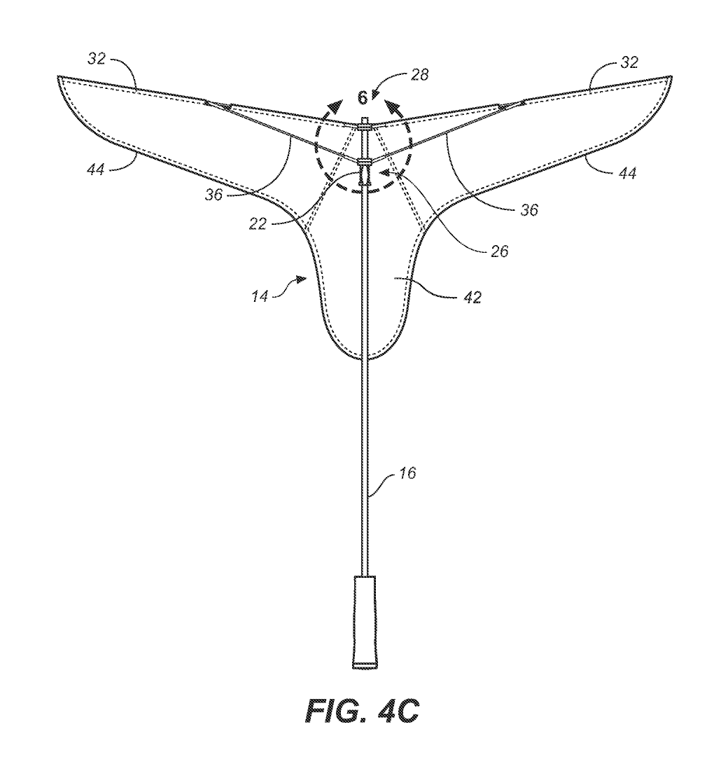

A collapsible goose flag according to the invention comprises a framework 12 and a flexible panel 14 attached to and supported by the framework as discussed below. The framework 12 can easily and quickly be arranged in an open configuration, such as shown in FIG. 3, or in a collapsed configuration, as shown in FIG. 4A.

With reference to FIG. 3, the framework 12 includes a shaft 16 provided with a handle 18 at its bottom end 20. A runner 22 is slidably disposed on the shaft 16 and is movable between a first position 24, shown in FIG. 4A, and a second position 26 is closer to the top end 28 of the shaft 16, as shown in FIG. 4C.

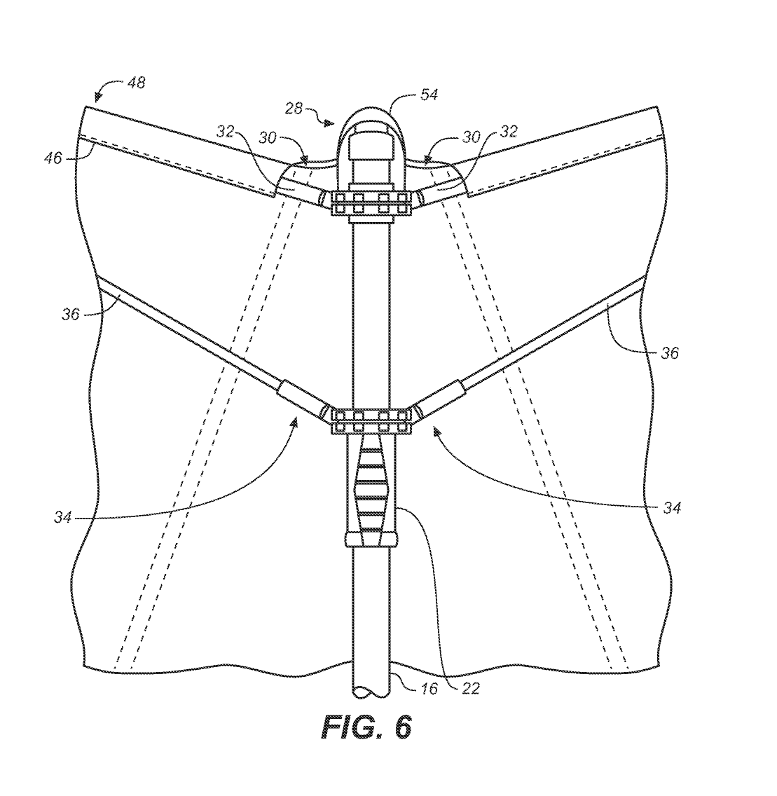

With additional reference to FIG. 6, the proximal end 30 of each of a pair of arms 32 is pivotally attached to the top end 28 of the shaft 16. The first ends 34 of a pair of support bars 36 are pivotally attached to the runner 22 and the second ends 38 of the support bars 36 are pivotally attached to the arms 32 between the proximal ends 30 and the distal ends 40 thereof.

The flexible panel 14 includes a body portion 42 and two wing portions 44 that extend wing-like from opposite sides of the body portion 42. The arms 32 of the framework 12 are received in pockets 46 provided in lead edges 48 of the wing portions 44. In the illustrated embodiment shown in FIG. 6, an elastic loop 54 is provided for placement around the top end 28 of the shaft 16 for securing the body portion 42 of the panel 14 to the shaft 16. The tail end 50 of the body portion 42 is attached to the shaft 16 so that the body portion 42 is extended along the shaft 16. In one embodiment, an elastic strip 52 extends from the tail end 50 to the shaft 16 thereby placing the body portion 42 under tension.

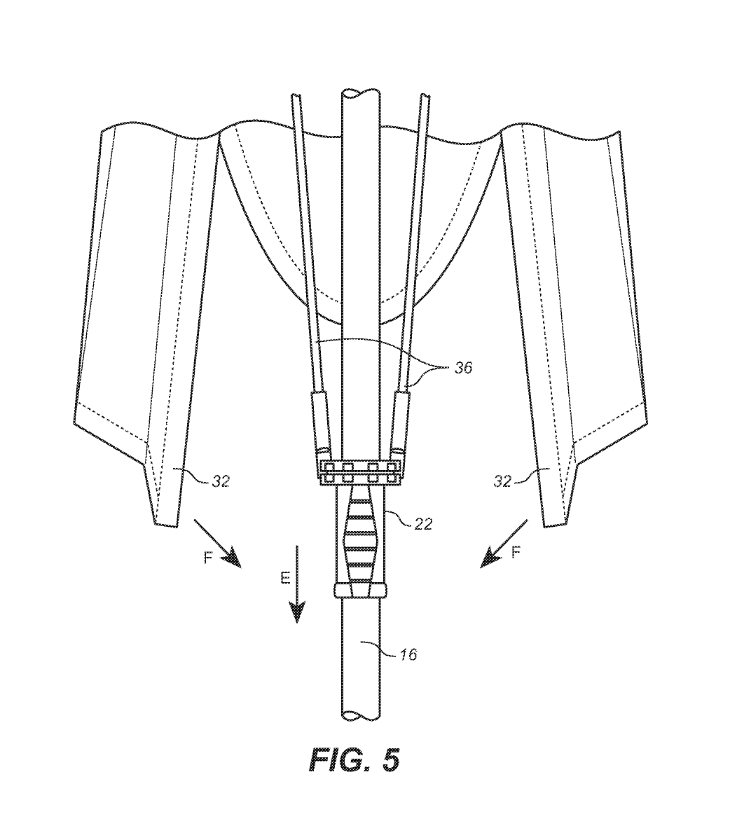

In the collapsed configuration shown in FIG. 4A the framework of the goose flag is collapsed such that the arms 32 and support bars 36 are positioned adjacent to and parallel with the shaft. With reference also to FIG. 5, the arms 32 are folded downward about their proximal ends 30 into parallel alignment with shaft 16, runner 22 is in the first position 24 along shaft 16, and the support bars 36 are also folded into parallel alignment with shaft 16 as shown. In the collapsed position, the flexible panel 14 collects around shaft 16 forming a compact arrangement convenient for storage and portability. From the collapsed configuration, upward movement of runner 22, as indicated in FIG. 4A by arrow A, will unfold the framework 12 upwardly as indicated by arrows B.

In FIG. 4B it is seen that the runner 22 has been moved upwardly along shaft 16, as indicated by arrow C, and arms 32 have been folded upwardly away from shaft 16 part way to a fully open configuration, as indicated by arrows D.

As shown in FIG. 4C the runner 22 has been moved to second position 26 and the arms 32 and support bars 36 have been moved into an open configuration in which arms 32 are extended generally perpendicularly from the top end 28 of shaft 16, support bars are also extended generally perpendicularly to shaft 16 in support of arms 32, the body portion 42 of panel 14 is stretched along shaft 16, and the wing portions 44 are extended perpendicularly from the body portion 42 such that the panel 14 resembles a waterfowl in flight.

FIG. 5 shows that in the collapsed configuration depicted in FIG. 4A support bars 36 are pivotally attached to runner 22 such that drawing downwardly on runner 22, toward the bottom end 20 of shaft 16 as indicated by arrow E, pulls arms 32 downwardly and inwardly toward shaft 16 as indicated by arrows F. In one aspect of the invention, a lock secures runner 22 in place.

In FIG. 6 runner 22 is shown in the second position 26 closer to the top end 28 of shaft 16. Here as well a lock secures runner 22 in place. Spring locks such as are commonly provided in the umbrella arts, are suitable locks for securing runner 22 in first and second positions 24, 26, but other locking mechanisms may be used as well.

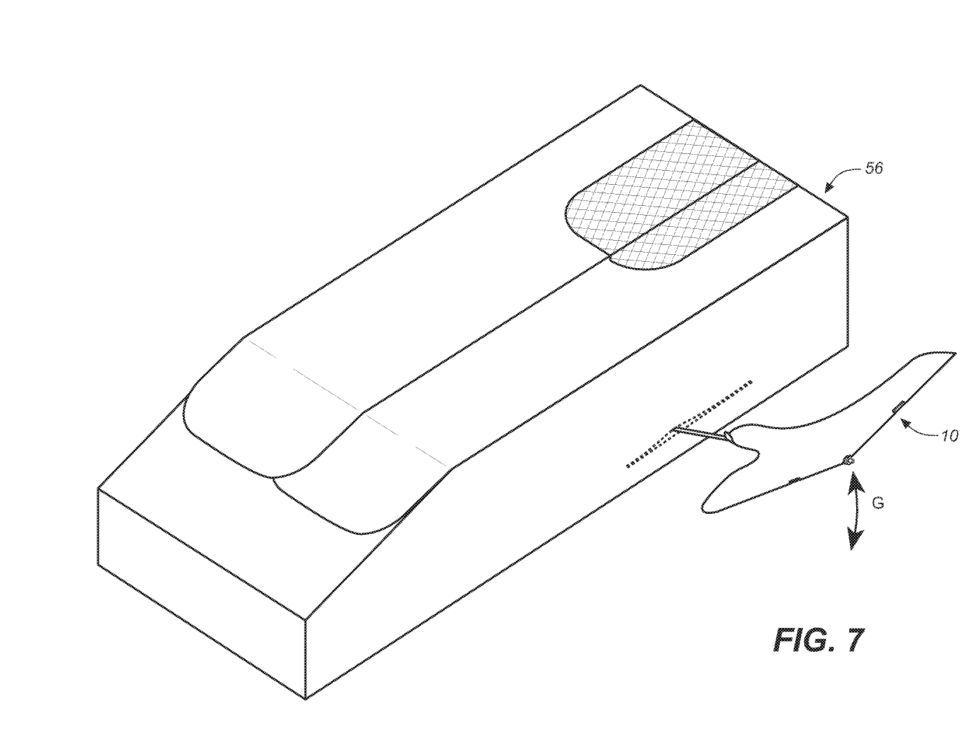

FIG. 7 shows a goose flag being extended from a typical laydown blind 56 and waved up and down as indicated by double arrow G to imitate a low-flying goose.

A collapsible goose flag according to the invention can be quickly and easily arranged in collapsed or open configurations as described above. The collapsible goose flag is compact and highly portable in the collapsed configuration and may be quickly deployed into the open configuration for field use.

There have thus been described and illustrated certain embodiments of a collapsible goose flag according to the invention. Although the present invention has been described and illustrated in detail, it should be clearly understood that the disclosure is illustrative only and is not to be taken as limiting, the spirit and scope of the invention being determined only by the terms of the appended claims and their legal equivalents.

1. A collapsible goose flag comprising:
a framework including a shaft, a runner, a pair of arms, and a pair of support bars, said shaft having a top end, said a runner movable relative to said shaft between a first position and a second position closer to the top end of said shaft than said first position, each of said arms having a proximal end, the proximal end of each arm pivotally attached to the top end of said shaft, each of said support bars having a first end and a second end, said first end pivotally attached to said runner and said second end pivotally attached to one of said arms, and
a flexible panel having a body portion and two wing portions extending from opposite sides of said body portion, said body portion having a tail end attached to said shaft, said wing portions attached to said arms,
said framework movable between collapsed and open configurations by moving said runner between said first and second positions,
wherein, in said collapsed configuration said runner is disposed in said first position, said arms and said support bars are disposed adjacent to and parallel with said shaft, and said panel is collapsed around said shaft, and
in said open configuration said runner is disposed in said second position, said arms and said support bars are extended perpendicularly from said shaft, the body portion of said panel is extended along said shaft and the wing portions of said shaft are extended perpendicularly to said shaft, such that said panel resembles a flying waterfowl.

2. The collapsible goose flag of claim 1 wherein:
in said open configuration, each of said arms, one of said support bars and said shaft form a triangle.

3. The collapsible goose flag of claim 1 further comprising:
said shaft including a bottom end having a handle.

4. The collapsible goose flag of claim 1 further comprising:
a first lock to hold said runner in said first position, and a second lock to hold said runner in said second position.

5. The collapsible goose flag of claim 1 wherein:
the body portion of said panel is stretched along said shaft.

6. The collapsible goose flag of claim 1 wherein:
each of said arms has a distal end, and
the second end of each of said support bars is attached to one of said arms between said proximal and distal ends thereof.

7. The collapsible goose flag of claim 1 wherein:
said runner is attached to and slides along said shaft.

8. The collapsible goose flag of claim 1 wherein:
the wing portions of said panel have forward edges attached to said arms.

9. The collapsible goose flag of claim 1 wherein:
in said open configuration, said arms are pivotal about an axis parallel with said shaft such that a waving movement of said shaft causes said arms and said wing portions to flap in a motion reminiscent of the flapping wings of a bird in flight.

10. The collapsible goose flag of claim 1 wherein:
said framework has a substantially planar disposition when deployed in said open configuration.

11. A collapsible goose flag comprising:
a framework including a shaft, a runner, a pair of arms, and a pair of support bars, said shaft having a top end, first and second locks, and a runner slidingly attached to and movable along said shaft between a first position and a second position closer to the top end of said shaft than said first position, said first lock for holding said runner said first position, said second lock for holding said runner said second position, each of said arms having a proximal end and a distal end, the proximal end of each arm pivotally attached to the top end of said shaft, each of said support bars having a first end and a second end, said first end pivotally attached to said runner and said second end pivotally attached to one of said arms between the proximal and distal ends thereof, and
a flexible panel having a body portion and two wing portions extending from opposite sides of said body portion, said body portion attached to the top end of said shaft and having a tail end attached to said shaft such that said body portion is extended along said shaft, said wing portions attached to said arms, said framework movable between collapsed and open configurations by sliding said runner between said first and second positions,
wherein, in said collapsed configuration said runner is disposed in said first position, said arms and said support bars are disposed adjacent to and parallel with said shaft, and said panel is collapsed around said shaft, and
in said open configuration said runner is disposed in said second position, said arms and said support bars are extended perpendicularly from said shaft, the body portion of said panel is extended along said shaft and the wing portions of said shaft are extended perpendicularly to said shaft, such that said panel has a substantially planar disposition resembling a flying waterfowl.
